(19) United States
(12) Patent Application Publication
(10) Pub. No.: US 2007/0086111 A1
(43) Pub. Date: Apr. 19, 2007

(54) Recording medium cartridge and fabrication method thereof

(75) Inventor: Hideaki Shiga, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/545,529

(22) Filed: Oct. 11, 2006

(30) Foreign Application Priority Data
Oct. 11, 2005 (JP) 2005-296794

(51) Int. Cl. G11B 23/02

(52) U.S. Cl. 360/132

(57) ABSTRACT

A recording medium cartridge includes an upper case and lower case made of resin, joined via joining portions which are respectively formed thereat. Mutually communicating hole portions are formed at the joining portions. At least one of the hole portions penetrates to a case outer face. A molten resin material is injected into the hole portions, and the injected resin material solidifies. Thus, the upper case and the lower case are joined together. A recording medium cartridge which enables an improvement in recyclability and is excellent for the environment, and a fabrication method thereof, are provided.

### CROSS-REFERENCE TO RELATED APPLICATION

This application claims priority under 35 USC 119 from Japanese Patent Application No. 2005-296794, the disclosure of which is incorporated by reference herein.

### BACKGROUND OF THE INVENTION

1. Field of the Invention

The present invention relates to a recording medium cartridge which accommodates a recording medium such as a magnetic tape or the like, which is principally employed as a recording/replaying medium of a computer or the like, within a case, and to a fabrication method thereof.

2. Description of the Related Art

Heretofore, a recording tape cartridge (recording medium cartridge) in which a recording tape such as a magnetic tape or the like is wound onto a single reel and the reel is accommodated in a case has been known, the recording tape of which is employed as a data recording/replaying medium of a computer or the like. The case of such a recording tape cartridge is structured by joining an upper case and lower case formed of a resin material together with screws made of metal or the like (see, for example, Japanese Patent Application Laid-Open (JP-A) No. 11-339436).

However, when the upper case and lower case are joined by screws made of metal, although this is preferable in regard to strength, problems with respect to the environment (recyclability) have arisen in that, when the recording tape cartridge is disposed of, it is necessary to separate metal-made components from resin-made components for disposal, and in that an anti-rust coating of the metal-made screws peels off and the screws rust, and so forth. A problem has also emerged with hexavalent chromium (a corrosion-prevention agent) which is included in the anti-rust coating being harmful to humans. Further, although a method of joining by ultrasonic welding is also known, such cases have also had problems in that high level engineering is necessary for design of a welding horn, for uniform welding and the like, and expensive equipment and long preparation times are required. Furthermore, with regard to recyclability again, there has been a problem in that when disassembly to an extent such that the recording medium (media) inside can be removed is attempted, it is difficult to break the welded portions.

Also known are a method of joining by engaging resilient engaging pawls which extend from one piece (for example, the upper case) with recess portions formed in the other piece (for example, the lower case) (see, for example, JP-A No. 2001-210056), a method of joining by engaging separate members which are provided with similar resilient engaging pawls with recess portions formed in the upper case and the lower case (see, for example, Japanese National Publication No 2003-533842), and so forth. However, in these cases, there have been problems with the resilient engaging pawls being broken and disengaged by impacts due to falls and the like, and problems with regard to reliable engagement, in that they are inferior to other joining methods. Furthermore, with regard to recyclability, there has been a problem in that it is very difficult for the engaging pawls, which have been strongly engaged so as not to be undesirably disengaged, to be disengaged by hand.

### SUMMARY OF THE INVENTION

Accordingly, an object of the present invention is to provide a recording medium cartridge which enables an improvement in recyclability and is excellent for the environment, and a fabrication method thereof.

In order to achieve the object described above, a recording medium cartridge relating to a first aspect of the present invention includes an upper case and lower case made of resin, which are joined via joining portions which are respectively formed at the upper case and lower case, and accommodates a recording medium thereinside, wherein the joining portions include hole portions which communicate with one another, at least one of the hole portions penetrating to an outer face of the cartridge, and the upper case and the lower case are joined by solidification of a molten resin material which has been injected into the hole portions.

A recording medium cartridge fabrication method relating to a second aspect of the present invention includes an upper case and lower case made of resin, which are joined via joining portions which are respectively formed thereat, and accommodates a recording medium thereinside, the recording medium cartridge fabrication method including the steps of: putting together the upper case and the lower case, the joining portions including hole portions which communicate with one another, at least one of which penetrates through; and joining the upper case with the lower case by injecting a molten resin material into the hole portions and solidifying the resin material.

According to the first and second aspects described above, because a joining member which joins the upper case with the lower case is a resin material, recyclability (disposability and re-usability) of the recording medium cartridge can be improved. Therefore, recording medium cartridges which are excellent for the environment can be provided.

In the recording medium cartridge of the above-described first aspect, the joining portions may be formed at peripheral walls of the upper case and the lower case.

According to the structure described above, because there is no need to provide the joining portions inside the case, efficiency of usage of space inside the case is improved.

In the recording medium cartridge of the above-described first aspect, the resin material may be a thermoplastic resin material of a variety the same as the upper case and the lower case.

Further, in the recording medium cartridge fabrication method of the above-described second aspect, the resin material may be a thermoplastic resin material of a variety the same as the upper case and the lower case.

According to the structures described above, recyclability (disposability and re-usability) of the recording medium cartridges can be further improved. Furthermore, joining characteristics at the joining portions can be improved.

In the recording medium cartridge of the above-described first aspect, the resin material may be a thermoplastic resin material with a lower melting point than a resin material of which the upper case and the lower case are molded.

Further, in the recording medium cartridge fabrication method of the above-described second aspect, the resin material may be a thermoplastic resin material with a lower melting point than a resin material of which the upper case and the lower case are molded.

According to the structures described above, it is possible to dismantle the upper case from the lower case simply by heating to a predetermined temperature. Therefore, recyclability (disposability and re-usability) of the recording medium cartridges can be further improved.

As described above, according to the present invention, a recording medium cartridge which enables an improvement in recyclability and is excellent for the environment, and a fabrication method thereof, can be provided.

### BRIEF DESCRIPTION OF THE DRAWINGS

FIG. 1 is a schematic perspective view of a recording tape cartridge.

FIG. 2 is a schematic exploded perspective view of a recording tape cartridge.

FIG. 3 is a schematic side sectional view showing joining portions of the recording tape cartridge.

FIG. 4 is a schematic side sectional view showing a state in which a thermoplastic resin material is being injected at the joining portions of the recording tape cartridge.

FIG. 5 is a schematic side sectional view showing other joining portions.

FIG. 6 is a schematic perspective view showing one part of the other joining portions.

### DETAILED DESCRIPTION OF THE INVENTION

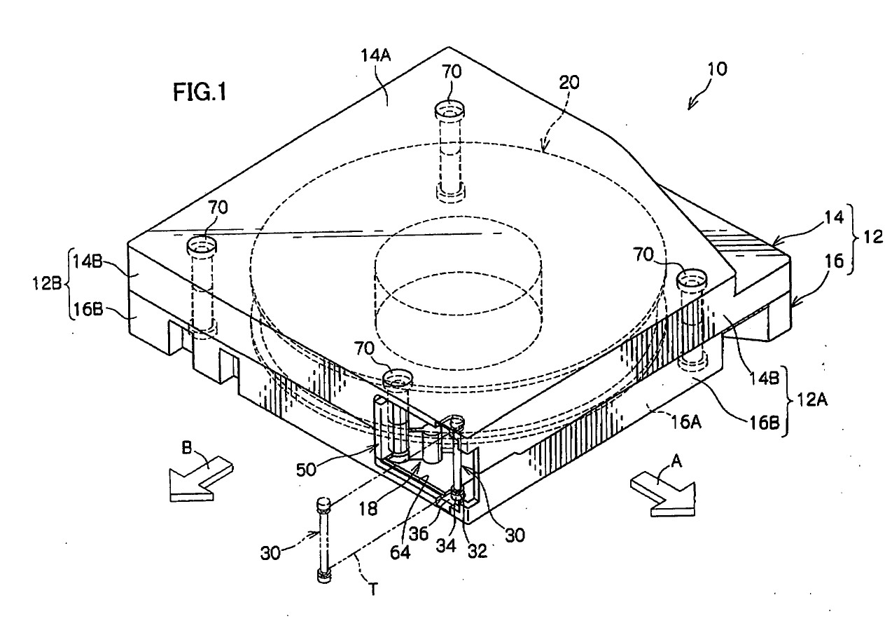

Herebelow, a best embodiment of the present invention will be described in detail on the basis of the examples shown in the drawings. Herein, as an example of a recording medium cartridge, a recording tape cartridge 10 will be described. For the sake of convenience in the descriptions, in FIG. 1, a direction of loading of the recording tape cartridge 10 into a drive device is shown by arrow A, and is treated as a forward direction (forward side) of the recording tape cartridge 10. The direction of an arrow B which is perpendicular to arrow A is treated as a rightward direction (right side).

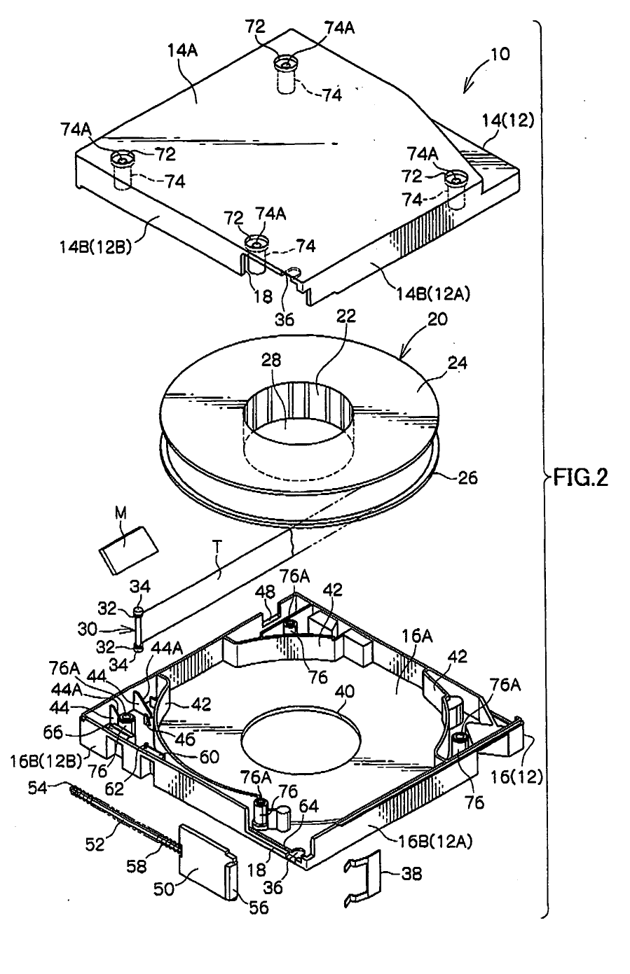

As shown in FIGS. 1 and 2, the recording tape cartridge 10 features a substantially rectangular box-form case 12. This case 12 is structured by joining together an upper case 14 and a lower case 16 which are made of a resin such as a polycarbonate (PC) or the like, with later-described joining means, in a state in which a peripheral wall 14B, which is provided standing from a peripheral edge of a ceiling plate 14A, and a peripheral wall 16B, which is provided standing from a peripheral edge of a floor plate 16A, respectively abut against one another.

A single reel 20 is rotatably accommodated inside the case 12. This reel 20 has a structure in which a reel hub 22, which has the form of a tube with a floor and structures an axial central portion, and a lower flange 26, which is provided at a lower end portion of the reel hub 22, are integrally formed, and an upper flange 24 is ultrasonically welded to an upper end portion of the reel hub 22. A recording tape T such as a magnetic tape or the like, which serves as an information recording/replaying medium, is wound round an outer peripheral face of the reel hub 22. Width direction end portions of the recording tape T that has been wound round are retained by the upper flange 24 and the lower flange 26.

A reel gear (not shown) is annularly formed at a lower face of a floor wall 28 of the reel hub 22. A gear opening 40, for exposing this reel gear to the outside, is formed through a central portion of the lower case 16. The reel gear which is exposed through this gear opening 40 meshes with a driving gear (not shown), which is formed at a rotary shaft (not shown) of the drive device, and is driven to rotate. Thus, the reel 20 in the case 12 can be relatively rotated with respect to the case 12.

An annular reel plate (not shown) formed of a magnetic material is fixed by insert-molding or the like at the lower face of the floor wall 28, at a radial direction inner side of the reel gear, and is attracted and retained by magnetism of an annular magnet (not shown) which is provided at the rotary shaft of the drive device. Further, the reel 20 is retained so as not to rattle by free play-restricting walls 42, which protrude from respective portions of inner faces of the upper case 14 and the lower case 16 to serve as an inner wall along a circular path which is concentric with the gear opening 40.

At a rear-right portion of the lower case 16, two support ribs 44 are provided standing with a predetermined separation in the left-right direction and, separated from these support ribs 44 by a predetermined separation in the front-rear direction, restricting ribs 46 are provided standing with a predetermined separation in the left-right direction. Front faces of the support ribs 44 are diagonal faces 44A, which are inclined at predetermined angles. A memory board M is disposed (retained) between these support ribs 44 (the diagonal faces 44A) and the restricting ribs 46, in a state of being inclined at a predetermined angle.

This is in order to enable correspondence with both the drive device, which gains access from the lower face (floor face) side of the case 12, and a library device (a device which accommodates a number of the recording tape cartridge 10 and automatically loads and removes the same at the drive device), which gains access from a rear face (back face) side. Herein, various kinds of information are recorded at the memory board M and, by communication with the drive device and the library device, reading of the information and, as required, writing (overwriting) of the information are possible.

An opening 18, for drawing out of the magnetic tape T which has been wound onto the reel 20, is formed in a right wall 12B of the case 12. A leader pin 30 is fixed at a free end portion of the recording tape T which is drawn out through this opening IS. The leader pin 30 is engaged (caught on) by a drawing-out member (not shown) of the drive device, and is drawn out and manipulated.

Annular grooves 32 are formed at two end portions 34 which protrude from recording tape T width direction end portions of the leader pin 30, These annular grooves 32 are engaged by hooks or the like of the drawing-out member. Thus, in this structure, the hooks or the like will not touch against and damage the recording tape T when the recording tape T is to be drawn out.

A pair of upper and lower pin-holding portions 36, which position and retain the leader pin leader pin 30 inside the case 12, are formed at the inner side of the opening 18 of the case 12, that is, in an inner face of the ceiling plate 14A of the upper case 14 and an inner face of the floor plate 16A of the lower case 16. These pin-holding portions 36 are formed in substantially semi-circular shapes which open to the side of drawing out of the recording tape T. In a standing state, two end portions 34 of the leader pin 30 are removably insertable into the pin-holding portions 36 from the opening side thereof

A plate spring 38 is fixedly disposed in a vicinity of the pin-holding portions 36. Distal end portions, at two levels, of this plate spring 38 respectively mesh with the upper and lower two end portions 34 of the leader pin 30 and retain the leader pin 30 at the pin-holding portions 36. In this structure, when the leader pin 30 is being inserted/removed at the pin-holding portions 36, the distal end portions of the plate spring 38 resiliently deform as appropriate and allow movement of the leader pin 30.

The opening 18 is openably closed by a door 50. This door 50 is formed in a substantially rectangular plate form with a size which is capable of closing off the opening 18. Groove portions 64, into which upper and lower end portions of the door 50 slidably fit, are formed in the ceiling plate 14A and the floor plate 16A at the inner side of the opening 18, such that the door 50 can move along the right wall 12B of the case 12 A shaft 52 is protrudingly provided from the middle of a rear end portion of the door 50. A coil spring 58 is fitted round this shaft 52. A broad portion 54, which serves to prevent the coil spring 58 from falling off, is formed at a rear end of the shaft 52. A support platform 60 is provided protruding from the lower case 16. The support platform 60 features an anchoring portion 62, which anchors a rear end of the coil spring 58 that is fitted round the shaft 52.

Consequently, the shaft 52 is slidably supported on the support platform 60, and the rear end of the coil spring 58 is anchored at the anchoring portion 62. Thus, the door 50 is a structure which is constantly urged in a direction for closing the opening 18 by urging force of the coil spring 58. Herein, it is preferable if a support platform 66, which supports the shaft 52 at a time of opening of the opening 18, is provided protruding further to a rearward side of the support platform 60.

A protrusion portion 56 for opening/closing operations is formed toward the outer side from a front end portion of the door 50. In accordance with mounting of the recording tape cartridge 10 into the drive device, this protrusion portion 56 engages with an opening/closing member (not shown) of the drive device. Hence, with this structure, the door 50 is opened in opposition to the urging force of the coil spring 58.

For the recording tape cartridge 10 structured as described above, operations thereof will now be described. At a time of non-use of the recording tape cartridge 10 with the above structure (during storage, during shipping or the like), the opening 18 is closed by the door 50, and the recording tape T is wound onto the reel hub 22 of the reel 20.

When the recording tape T is to be used, with a front wall 12A facing forward, the recording tape cartridge 10 is loaded into a drive device in the direction of arrow A. Correspondingly, first, the opening/closing member provided at the drive device engages with the protrusion portion 56 of the door 50. Hence, when the recording tape cartridge 10 moves further in the direction of arrow A in this state, the opening/closing member moves the protrusion portion 56 relatively rearward in opposition to the urging force of the coil spring 58, and the door 50 at which the protrusion portion 56 is protrudingly provided slides to rearward along the right wall 12B in the groove portions 64, and opens up the opening 18.

Hence, when the recording tape cartridge 10 has been loaded to a predetermined depth in the drive device and the opening 18 has been fully opened, the recording tape cartridge 10 descends by a predetermined height, and a positioning member (not shown) of the drive device enters into a hole portion for positioning (not shown), which is formed in the lower case 16. Thus, the recording tape cartridge 10 is precisely positioned at a predetermined position in the drive device, and further sliding (movement to rearward) of the door 50 is restricted.

As a result of the descending operation of the recording tape cartridge 10, the rotary shaft relatively advances in through the gear opening 40, and the driving gear meshes with the reel gear. Hence, in a state in which the driving gear and the reel gear are fully meshed, the reel plate is attracted and retained by the magnetism of the annular magnet provided at the inner side of the driving gear. Thus, the reel 20 is put into a lock-release state, in which relative rotation, with respect to the case 12, of the reel 20 in the case 12 is possible, while the meshing of the reel gear with the driving gear is maintained.

Meanwhile, the drawing-out member provided at the drive device side advances into the case 12 through the opening 18 which has been opened up, takes hold of the leader pin 30 which has been positioned and retained at the pin-holding portions 36, and draws out the same. At this time, because the recording tape cartridge 10 has been precisely positioned in the drive device, the drawing-out member can reliably engage hooks thereof with the annular grooves 32 of the leader pin 30.

Then, the leader pin 30 which has been taken out through the opening 18 is accommodated in an unillustrated take-up reel. Hence, this take-up reel and the reel 20 are driven to rotate synchronously, and thus the recording tape T is sequentially drawn out from the case 12 while being wound onto the takeup reel, and recording and/or replaying of information is performed by a recording head (not shown) which is disposed on a predetermined tape path.

When the recording tape cartridge 10 at which recording and/or replaying of information has been completed is to be ejected from the drive device, first, the rotary shaft rotates in reverse and thus the recording tape T is wound back to the reel 20. Then, when the recording tape T has been wound back all the way onto the reel 20 and the leader pin 30 has been retained in the pin-holding portions 36, the recording tape cartridge 10 ascends by the predetermined height, the positioning member is taken out from the hole portion for positioning, the rotary shaft is taken out through the gear opening 40, and the meshing of the driving gear with the reel gear is released.

Thereafter, the recording tape cartridge 10 is moved in the direction opposite to the direction of arrow A by an unillustrated ejection mechanism Correspondingly, in accordance with this movement, the door 50 slides in the direction for closing the opening 18 due to the urging force of the coil spring 58, and fully closes off the opening 18 (i.e., returns to the original state thereof). Hence, the recording tape cartridge 10 of which the opening 18 has been closed is completely ejected from inside the drive device.

For the recording tape cartridge 10 as described above, a fabrication method thereof (the joining means of the upper case 14 and the lower case 16) will now be described. As shown in FIG. 2, a plurality (four in the illustrated case) of bosses 74, which serve as joining portions featuring through-holes 74A, are formed at the upper case 14 at predetermined positions (vicinities of corner portions of the upper case 14). At the lower case 16, a plurality (four in the illustrated case) of bosses 76, which serve as joining portions featuring through-holes 76A, are formed at predetermined positions (vicinities of corner portions of the lower case 16) to be able to abut against (fit with) the bosses 74 when the upper case 14 and the lower case 16 are put together.

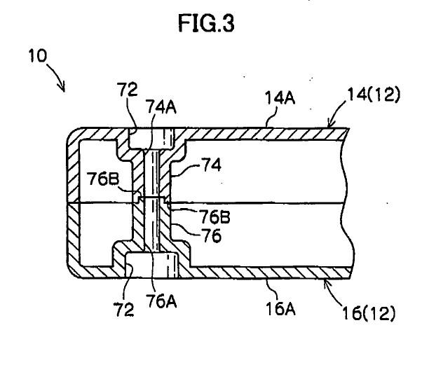

As shown in FIG. 3, at a distal end portion (lower end portion) of each boss 74, a step portion 74B which protrudes to downward is formed at an outer peripheral face side. At a distal end portion (upper end portion) of each boss 76, a step portion 76B which protrudes to upward is formed at an inner peripheral face side at which the through-hole 76A is formed.

When the upper case 14 and lower case 16 are put together, these step portions 74B and 76B abuttingly fit together, and the through-holes 74A and 76A communicate with one another. In this state, a molten thermoplastic resin material 70 is injected from the lower face side of the floor plate 16A (or possibly from the upper face side of the ceiling plate 14A).

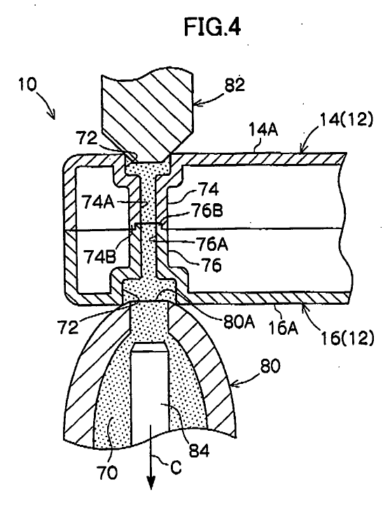

Specifically, for example, as shown in FIG. 4, a nozzle 80 is set to oppose the through-hole 76A formed in the floor plate 16A, and a holding member 82 is set to oppose the through-hole 74A formed in the ceiling plate 14A. This holding member 82 is constituted of a resin with a higher melting point than the thermoplastic resin material 70, or a metal or the like.

In this state, an opening/closing valve 84 is moved in the direction of an arrow C (downward in FIG. 4) and opens an ejection aperture 80A. As a result, the molten thermoplastic resin material 70 is injected through this ejection aperture 80A into the through-holes 76A and 74A. At this time, because a structure is formed in which the step portion 74B of the boss 74 abuttingly fits to the step portion 76B of the boss 76, there is no risk of the thermoplastic resin material 70 leaking to the interior of the case 12 through this abutting fitting portion.

Moreover, in accordance with this abutting fitting, there is an effect in that rattling of the upper case 14 and lower case 16 in horizontal directions (directions intersecting the direction of putting together) is prevented. Furthermore, a structure is possible in which an unillustrated heat-insulating material is provided at least around the ejection aperture 80A of the nozzle 80, in order to reliably prevent the lower case 16 from melting due to heat originating from the nozzle 80.

Recess portions 72, with predetermined depths and diameters greater than the through-holes 74A and 76A, are formed in the upper face of the ceiling plate 14A and the lower face of the floor plate 16A, around the through-holes 74A and 76A. Therefore, this is a structure in which, when the thermoplastic resin material 70 that has been filled in as far as the interiors of the recess portions 72 solidifies, the upper case 14 and the lower case 16 cannot move apart, and therefore is a structure in which the upper case 14 and the lower case 16 are firmly joined together (to an extent which is strongly resistant even to the application of an impact due to a fall or the like),

Now, this thermoplastic resin material 70 is preferably a thermoplastic resin material of a variety the same as a thermoplastic resin material of which the upper case 14 and the lower case 16 are molded, and alternatively is preferably a thermoplastic resin material with a lower melting point than a thermoplastic resin material of which the upper case 14 and the lower case 16 are molded. If the thermoplastic resin material 70 is a thermoplastic resin material of the same variety, characteristics of joining of the upper case 14 with the lower case 16 can be improved. If the thermoplastic resin material 70 is a thermoplastic resin material with a lower melting point, there is an advantage in that when the upper case 14 and lower case 16 are to be disassembled, the thermoplastic resin material 70 that has been employed for joining can be melted simply by heating to a predetermined temperature, and easy disassembly is possible.

Specifically, if the thermoplastic resin of which the upper case 14 and the lower case 16 are molded is polycarbonate (PC), the thermoplastic resin material 70 that is employed for the joining is acrylonitrile butadiene styrene (ABS), polyacetal (POM), polyethylene (PE), polypropylene (PP) or the like. Further, if the thermoplastic resin of which the upper case 14 and the lower case 16 are molded is acrylonitrile butadiene styrene (ABS), the thermoplastic resin material 70 that is employed for the joining is polyacetal (POM), polyethylene (PE), polypropylene (PP) or the like.

Anyway, recyclability of the recording tape cartridge 10 can be improved by forming such structures. That is, when joining members are the thermoplastic resin material 70 and the shapes of the bosses 74 and 76 (the through-holes 74A and 76A) which are joining portions are crafted (i.e., when the recess portions 72 are formed), the upper case 14 and the lower case 16 can be firmly joined together without employing a harmful material which will be harmful to humans or pollute the environment, such as hexavalent chromium.

Because it is not necessary to separate each material when the recording tape cartridge 10 is to be discarded, re-use of resin materials and the like that have been used in the recording tape cartridge 10 can be made easier. Therefore, the recording tape cartridge 10 can be provided to be excellent for the environment. Further, in a case in which it is necessary to disassemble to remove the reel 20 (the recording tape T), the memory board M or the like, as described above, the thermoplastic resin material 70 can be melted alone, and therefore it is possible to easily disassemble the upper case 14 from the lower case 16 for removal.

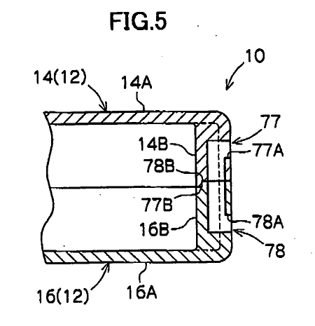

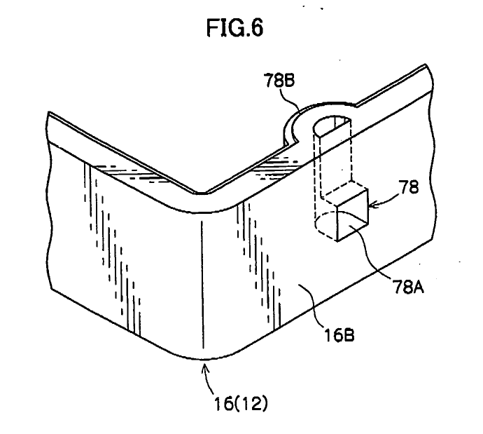

Further, as described above, provided the joining portions that are respectively formed at the upper case 14 and the lower case 16 are structured such that the upper case 14 and the lower case 16 cannot be moved apart, there is a degree of freedom in regard to formation positions, shapes and the like of the joining portions. Accordingly, another example of these joining portions will now be described, on the basis of FIGS. 5 and 6.

As shown in FIGS. 5 and 6, such joining portions 77 and 78 are formed in the peripheral wall 14B of the upper case 14 and the peripheral wall 16B of the lower case 16, respectively. That is, in the peripheral wall 14B of the upper case 14, a hole portion 77A is formed with a substantially ‘L’-shaped form in a vertical direction sectional view (with openings emerging at a joining face and an outer wall face), and in the peripheral wall 16B of the lower case 16, a hole portion 78A is formed with a substantially ‘L’-shaped form in a vertical direction sectional view (with openings emerging at a joining face and an outer wall face).

Thus, a structure is formed in which, when the upper case 14 and the lower case 16 are put together and the peripheral walls 14B and 16B are abutted against one another, the hole portion 77A formed in the upper case 14 and the hole portion 78A formed in the lower case 16 can communicate with one another. Of course, a plurality of sets of these joining portions 77 and 78 are formed, at suitable positions of the peripheral walls 14B and 16B At a distal end portion (upper end portion) of the joining portion 78, a step portion 78B which protrudes to upward is formed at an outer wall face side thereof, and at a distal end portion (lower end portion) of the joining portion 77, a step portion 77B which protrudes to downward is formed at the inner wall face side thereof. Thus, when the upper case 14 and the lower case 16 are put together, these step portions 77B and 78B abuttingly fit together.

Accordingly, for example, the nozzle 80 is disposed in opposition to the hole portion 77A (or the hole portion 78A) and the holding member 82 is disposed in opposition to the hole portion 78A (or the hole portion 77A), and the thermoplastic resin material 70 is injected through the hole portion 77A. At this time, there is no risk of the thermoplastic resin material 70 leaking to the interior of the case 12 through this abutting fitting portion.

Because the hole portions 77A and 78A are formed in the substantially ‘L’-shaped forms in vertical direction sectional views, the upper case 14 and the lower case 16 can be made incapable of moving apart when the injected thermoplastic resin material 70 solidifies. That is, the upper case 14 can be firmly joined with the lower case 16. Moreover, because the joining portions 77 and 78 are formed in the peripheral walls 14B and 16B, there is an advantage in that space inside the case 12 can be even more efficiently used than in the case as described above in which the bosses 74 and 76 are formed as the joining portions.

Hereabove, because the joining member which is employed for joining the upper case 14 with the lower case 16 is the thermoplastic resin material 70, the recording tape cartridge 10 (recording medium cartridge) relating to the present invention in whatever form can ease disposal and re-use of the recording tape cartridge 10. That is, recyclability of the recording tape cartridge 10 can be improved. Therefore, the recording tape cartridge 10 can be provided to be excellent for the environment.

Moreover, a recording medium cartridge relating to the present invention is not limited to the recording tape cartridges 10 of the drawings and can be applied to, for example, a disc cartridge or the like, of which the upper case 14 and lower case 16 are joined together by joining portions. Further, formation positions, shapes and the like of the joining portions (the through-holes 74A and 76A, the hole portions 77A and 78A or the like) are not limited to the embodied examples (the illustrated forms): suitable design modifications are possible within a scope not departing from the spirit of the present invention.

For example, the shapes of the hole portions 77A and 78SA are not limited to forms in which the abutting face side has a semi-circular shape in plan view and the outer wall face side has a substantially rectangular shape in elevational view, as shown in FIG. 6. A structure in which the outer wall face opening of the hole portion 78A of the peripheral wall 16B is closed off is also possible. Hence, even though the hole portion 78A of the peripheral wall 16B is not a through-hole, as long as this hole portion 78A is formed in a substantially ‘L’-shaped form in a vertical direction sectional view, or the like, the upper case 14 and the lower case 16 will be firmly joined together and this will not be problematic.

What is claimed is:

1. A recording medium cartridge which comprises an upper case and lower case made of resin, which are joined via joining portions which are respectively formed at the upper case and lower case, and accommodates a recording medium thereinside,
wherein the joining portions include hole portions which communicate with one another, at least one of the hole portions penetrating to an outer face of the cartridge, and the upper case and the lower case are joined by solidification of a molten resin material which has been injected into the hole portions.

2. The recording medium cartridge of claim 1, wherein the joining portions are formed at peripheral walls of the upper case and the lower case.

3. The recording medium cartridge of claim 1, wherein the resin material comprises a thermoplastic resin material of a variety the same as the upper case and the lower case.

4. The recording medium cartridge of claim 1, wherein the resin material comprises a thermoplastic resin material with a lower melting point than a resin material of which the upper case and the lower case are molded.

5. The recording medium cartridge of claim 1, wherein the at least one penetrating hole portion extends to at least one of an upper face of the upper case and a lower face of the lower case.

6. A method for fabrication of a recording medium cartridge which includes an upper case and lower case made of resin, which are joined via joining portions which are respectively formed thereat, and accommodates a recording medium thereinside, the recording medium cartridge fabrication method comprising the steps of:
putting together the upper case and the lower case, the joining portions including hole portions which communicate with one another, at least one of which penetrates through; and
joining the upper case with the lower case by injecting a molten resin material into the hole portions and solidifying the resin material.

7. The recording medium cartridge fabrication method of claim 6, wherein the resin material is a thermoplastic resin material of a variety the same as the upper case and the lower case.

8. The recording medium cartridge fabrication method of claim 6, wherein the resin material is a thermoplastic resin material with a lower melting point than a resin material of which the upper case and the lower case are molded.

9. A recording medium cartridge which accommodates a recording medium thereinside, the cartridge comprising;
an upper case and lower case made of resin which are joined to one another, the upper case and the lower case respectively including joining surfaces which abut against one another, hole portions which communicate with one another being formed extending respectively into the upper case and the lower case from faces thereof at the joining surfaces, and at least one of the hole portions reaching to an outer face of the at least one of the upper case and the lower case; and
a joining member formed of a resin material, which continuously extends in the hole portions of the upper case and the lower case, and joins together the upper case and the lower case.

10. The recording medium cartridge of claim 9, wherein the joining member is formed by solidification of a molten resin material which has been injected into the hole portions.

11. The recording medium cartridge of claim 9, wherein the joining surfaces are formed at peripheral walls of the upper case and the lower case.

12. The recording medium cartridge of claim 9, wherein the joining member comprises a thermoplastic resin material of a variety the same as the upper case and the lower case.

13. The recording medium cartridge of claim 9, wherein the joining member comprises a thermoplastic resin material with a lower melting point than a resin material of which the upper case and the lower case are molded.

14. The recording medium cartridge of claim 9, wherein the outer face includes at least one of an upper face of the upper case and a lower face of the lower case.
